(19) United States
(12) Patent Application Publication
(10) Pub. No.: US 2002/0024631 A1
(43) Pub. Date: Feb. 28, 2002

(54) Rotationally stabilized contact lenses

(76) Inventors: Jeffrey H. Roffman, Jacksonville, FL (US); Brett A. Davis, Cooparoo (AU); Michael J. Collins, Mt. Nebo (AU); Alex T. Washington, Jacksonville, FL (US); Steven Newman, New Farm (AU)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/901,505

(22) Filed: Jul. 9, 2001

Related U.S. Application Data
(63) Continuation-in-part of application No. 09/387,321, filed on Aug. 31, 1999.

(51) Int. Cl. G02C 7/04

(52) U.S. Cl. 351/161; 351/160 R

(57) ABSTRACT

The invention provides contact lenses that incorporate a coaxial stabilization zone to stabilize the orientation of the lens in relation to the eye.

### FIELD OF THE INVENTION

The invention relates to contact lenses. In particular, the invention provides contact lenses that incorporate a coaxial stabilization zone to stabilize the orientation of the lens in relation to the eye.

### BACKGROUND OF THE INVENTION

It is known that the correction of certain optical defects can be accomplished by imparting non-spherical corrective characteristics into a contact lens, such as cylindrical, bifocal, or multifocal characteristics. Additionally, advances in technology permit production of customized lenses or lenses based on an individual's corneal topographic measurements, wave front measurements, or both. The use of customized contact lenses or lenses with certain corrective characteristics may be problematic in that the lens may need to be maintained at a specific orientation while on the eye to be effective. However, the lenses will rotate on the eye due to blinking as well as eyelid and tear fluid movement.

Lenses designed to maintain their on-eye orientation typically are of two general types. One type uses prism stabilization, or thickening of certain lens portions, to maintain orientation. Examples of prism stabilization methods include decentering the front relative to the back lens surface, prismatic balancing, thickening of the lower lens edge, supporting the lens on the lower eyelid, forming depressions or elevations on the lens' surface, and truncating the lens edge.

A second lens type, dynamically stabilized lenses, uses the movement of the eyelids to maintain lens orientation. Dynamic stabilization methods include reducing the thickness of the lens' outer surface at two symmetrically lying regions, thickening two outer regions in the horizontal center axis, and thinning, or slabbing off, top and bottom zones on the lens.

The known methods for maintaining lens orientation suffer from a number of disadvantages including that lenses incorporating the methods require specialized, off-axis tooling for production, that these lenses are uncomfortable to wear, and that the known methods are not highly effective. Thus, a need exists for a method of maintaining angular orientation that overcomes some or all of these disadvantages.

### BRIEF DESCRIPTION OF THE DRAWINGS

FIG. 1 illustrates a plan view of the convex surface of a number of embodiments of the lenses of the invention.

FIG. 2 illustrates a plan view of the convex surface of a preferred embodiment of the lens of the invention.

### DETAILED DESCRIPTION OF THE INVENTION AND PREFERRED EMBODIMENTS

It is a discovery of the invention that rotationally stabilized contact lens may be obtained by incorporating a coaxial stabilization zone into a lens, the common axis for the coaxial stabilization zone being the Z axis. The invention provides an effective method, and lenses incorporating that method, for on-eye lens stabilization. Additionally, the lenses may be produced using a computer numerically controlled coding without the need for specialized, off-axis tooling.

In one embodiment, the invention provides a method for producing contact lenses comprising, consisting essentially of, and consisting of: a.) defining at least one coaxial stabilization zone having a common axis of Z for at least one surface of a contact lens; b.) determining parameters for at least one area of thickness, thinness, or both within the coaxial stabilization zone; and c.) calculating a surface design for the at least one surface. In another embodiment, the invention provides a contact lens comprising, consisting essentially of, and consisting of at least one coaxial stabilization zone having a common axis of Z and comprising at least one area of thickness, thinness, or both.

The lenses of the invention may be either hard or soft contact lenses. Preferably, the lenses are soft contact lenses. The stabilization zone may be located on the convex, or front surface, the concave, or back surface, or both surfaces. Preferably, the stabilization zone is on the convex surface.

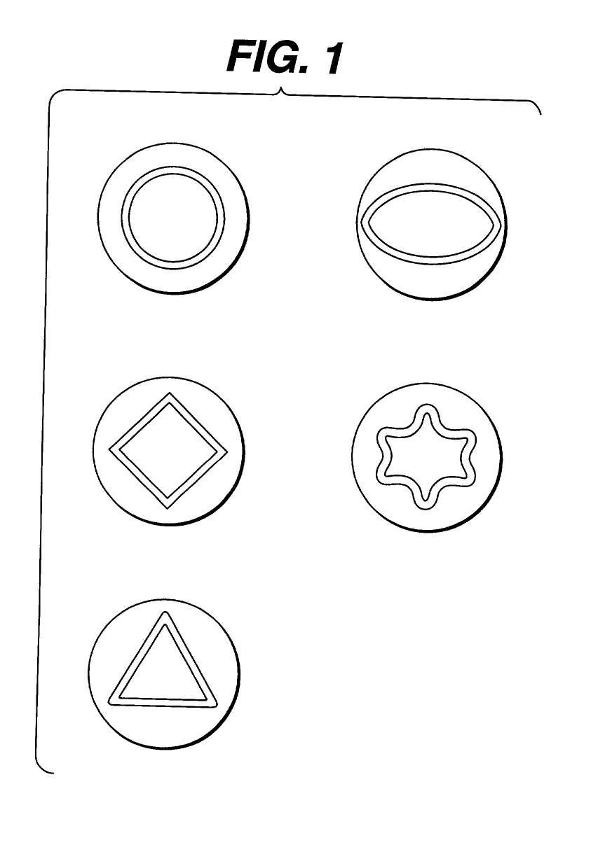

The invention may find its greatest utility in customized lenses, such as lenses with topographically-derived surfaces or surfaces calculated from wave front measurements, or lenses in which at least one of the corrective characteristics requires that the on-eye orientation of the lens with respect to the eye remains stable in one position, such as a toric lens. In the first step of the method of the invention, the stabilization zone is defined meaning that its shape, size, and location are defined. Any shape may be used for the coaxial stabilization zone including, without limitation, a shape that is substantially circular, ovoid, rhomboid, triangular, and the like. Referring to FIG. 1, a number of the wide variety of possible shapes are shown. Preferably, the stabilization zone will assume a substantially circular shape.

The size and location of the zone is such that the zone extends from a point on or outside of the outer edge of the optic zone to a point at or inside of the lens edge. For purposes of the invention, “outer edge of the optic zone” means that portion of the optic zone farthest from the lens' geometric center. Thus, it represents the farthest peripheral point of the central optic zone, which zone provides corrective optical power to the lens wearer. Preferably, the coaxial stablization zone extends from about 0 mm outside of the outer edge of the optic zone to about 1 mm inside of the lens edge, more preferably from about 1 mm outside of the outer edge of the optic zone to about 1 mm inside of the lens edge. Most preferably, the width of the stabilization zone is about 3 to about 6.5 mm.

In a second step, the parameters of at least one area of thickness, thinness, or both, within the coaxial zone are determined. More specifically, the location and contour of the these areas are determined. The thick and thin areas may be located at any axis. However, if the lens is a toric lens or a customized lens, preferably any thickness areas will be located at below the horizontal axis, or 0 and 180° line, and any thinned area will be above that line. If more than one area of thickness, thinness, or both are used, the thickness areas each may be about the same radial distance from the lens' center or this distance may vary, but preferably, all of the thick areas are below and all of the thin areas above the 0-180 degree line.

Preferably, the areas of thinness, or thinned areas, useful in the invention are discrete, concave areas laying below the curved surface of the lens. Similarly, the areas of thickness, or thickened areas, are preferably discrete convex areas rising above the curved surface of the lens. The areas may be of any suitable diameter, which diameter will be determined based on the type of lens in which they are used and the degree of rotational stabilization desired.

Preferably, the thickened or thinned areas begin at or just inside of the inner edge of stablization zone, which edge is the closest to the geometric center of the lens. Each of the areas ranges from 0 to a maximum departure from the surrounding lens surface and then back to 0 at or inside of the outer edge of the stabilization zone, or the edge farthest from the geometric center of the lens. For example, a cross section of the lens through a thickened area will depict an area gradually increasing in height from 0 to a maximum above the lens surface and then returning to 0. Additionally, moving circumferentially around the lens, the thickened and thinned areas also increase in amplitude from 0 to the maximum departure from the lens surface and back to 0.

The areas of thickness and thinness may assume any of wide variety of shapes including, without limitation, substantially circular, ovoid, triangular, square, polygonal, or the like. Preferably, the areas are substantially circular or ovoid, more preferably, substantially circular.

It is preferred that the number of thickened and thinned areas used be the minimum necessary to achieve the desired stabilization and still permit convenient manufacture of the lens. Typically, it is desirable for a lens to maintain its rotational position for at least about five minutes. More preferably, either one or two thinned areas are used in conjunction with two thickened areas.

To determine the contour of the thickened and thinned areas, any periodic function may be used that provides the desired contour. Typically, the contour will be either a single or double peak. Suitable periodic functions include, without limitation, linear functions and their derivatives, sine or cosine functions and their derivatives, exponential functions, Gaussian functions, conic functions such as circles, ellipses, parabolas, hyperbolas, and the like, cycloid functions, splines, polynomial functions of any order, filter functions, notch functions, bandpass filter functions, Witch of Agnesi functions, hyperbolic trigonometric functions, catenary functions, and the like, and combinations thereof.

Alternatively, and preferably, the contours may be empirically derived as follows. The thickness differential between the lens and the thickened areas, thinned areas, or both, their amplitudes, numbers, and positions are selected based on the rotational stabilization desired for the lens. The contour of the thickened or thinned area is then configured so that its juncture with the lens surface is smooth and comfortable to the lens wearer. Preferably, it is also selected so that it is within the mechanical frequency response capability of a commercially available CNC lathe with asymmetric capability such as the VARIFORM™ lathe available from Precitech, Tampa Fla.

The maximum thickness, or height above the lens surface, of the thickened areas may be about 100 to about 300, preferably about 100 to about 175 μm. The maximum thinness of the thinned areas may be about 25 to about 50 μm, meaning that the peak of the thin area is at about 25 to about 50 μm below the lens surface.

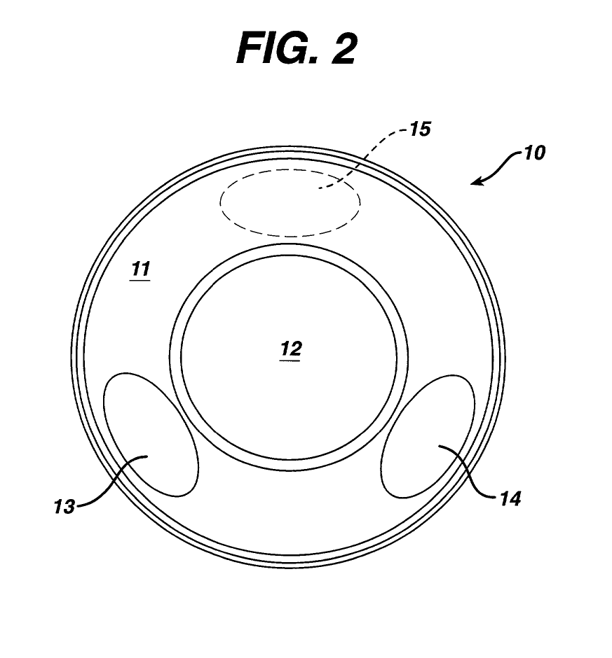

The coaxial stabilization zones of the invention may be formed by any of a wide variety of methods. Suitable methods include, without limitation, adding thickness to or subtracting thickness from the lens surface. FIG. 2 illustrates lens 10, a preferred embodiment, having substantially circular stabilization zone 11 and optic zone 12. Lens 10 has discrete, convex thickened areas 13 and 14 at the inferior portion of the lens and each independently centered at about the 210 and 330 degrees, respectively, using the horizontal axis, the 0-180 degree line as a reference. Area 13 begins at about 165 degrees and ends at about 255 degrees and area 14 begins at about 285 degrees and ends at about 15 degrees. Discrete, concave thinned area 15 is located at the superior portion centered at 90 degrees. Area 15 begins at about 60 degrees and ends at about 120 degrees. The three areas are substantially equally spaced apart and are the same radial distance from the lens' center.

Calculating the surface design for the lens may be carried out by any known method for designing a contact lens surface. The surfaces of the lenses of the invention may have any of a variety of corrective optical characteristics incorporated onto either or both the convex and concave surfaces. For example, the lens may have any one or more of spheric, aspheric, bifocal, multifocal, prismatic, or cylindric corrections, or combinations thereof. Additionally, one or more surfaces of the lens may be surfaces calculated from topographic measurements, or topographically-derived surfaces, surfaces calculated from wave front measurements, and the like and combinations thereof.

The manner in which the stabilization zones of the invention act to stabilize the lens will depend upon the location and shape of the zone. For example, the thickened zones in FIG. 2 act as a wedge to ballast the lens while the thinned area permits the lid to more tightly fit against the lens.

The lenses of the invention may be produced by any conventional method for producing contact lenses. For example, the lens design may be cut into a metal and the metal used to produce plastic mold inserts for the lens' surfaces. A suitable liquid resin is then placed between the inserts, the inserts compressed, and the resin cured to form the lens. Alternatively, the lens of the invention may be produced by cutting the lens on a lathe. One ordinarily skilled in the art will recognize that an advantage of the invention is that the lenses may be produced by the use of on-axis CNC lathing of the lenses or mold tools to produce the lenses.

The lenses may be produced using any material suited for manufacturing contact lenses. Preferably, the material selected for forming the lenses of the invention is a material suitable for forming soft contact lenses. Suitable materials for forming such contact lenses using the method of the invention include, without limitation, silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, such as etafilcon A.

The invention may be clarified by the following, non-limiting example.

### EXAMPLE

A coaxial stabilization zone for a lens with a topographically-derived surface was empirically derived, the zone having one thin area and two thick areas. Relative to the lens' geometric center, the coaxial stabilization zone had an inner diameter of approximately 8 mm and an outside diameter of approximately 14 mm. The thickened and thinned areas were at their maximum height above and depth below, respectively, the lens surface at approximately 12 mm. The thick areas were centered at 210 and 330 degrees on the lens and the thin area at 90 degrees. The areas were approximately 120 degrees from each other.

A lens incorporating the coaxial stabilization zone was made by diamond-turning toll inserts, producing cast molds, and casting a lens using etafilcon A. The rotational stabilization of the lens was tested by placing the lens on the eyes of 10 individuals and observing the lens with a Slit Lamp Biomicroscope. The lenses were inserted spot on or at the intended orientation, at 45 degrees nasally and temporally and 180 degrees away from the intended orientation. The final position of the each lens after the lens stopped rotating for at least 5 minutes was evaluated for orientation and stability at that orientation.

The results of the study indicated that the coaxial stabilization was superior to conventional stabilization methods both in terms of wearer comfort and the final position of the lens being closer to the intended orientation.

What is claimed is:

1. A contact lens comprising at least one coaxial stabilization zone having a common axis of Z and comprising at least one area of thickness, thinness, or both.

2. The lens of claim 1, wherein the lens is a soft contact lens.

3. The lens of claim 2, wherein the at least one coaxial stabilization zone is on a convex surface, a concave surface, or both surfaces.

4. The lens of claim 2, wherein the coaxial stabilization zone is on the convex surface.

5. The lens of claim 2, wherein the coaxial stabilization zone is substantially circular in shape.

6. The lens of claim 2, wherein the coaxial stabilization zone extends from about 0 mm outside of an outer edge of an optic zone to about 1 mm inside of a lens edge.

7. The lens of claim 2, wherein the surface on which the coaxial stabilization zone is located is a surface calculated from topographic measurements, wavefront measurements, or combinations thereof.

8. The lens of claim 2, wherein the surface on which the coaxial stabilization zone is located is a surface calculated from topographic measurements.

9. The lens of claim 2, wherein the surface on which the coaxial stabilization zone is located is a surface calculated from wavefront measurements.

10. The lens of claim 7, 8, or 9, wherein the coaxial stabilization zone comprises a discrete, concave thinned area centered at about the 90° axis and a first discrete, thickened convex area centered at about 210° and a second discrete, thickened convex area one is centered at about 330°.

11. The lens of claim 10, wherein the coaxial stabilization zone is substantially circular.

12. The lens of claim 7, 8, or 9, wherein the coaxial stabilization zone comprises a first discrete, concave thinned area centered at about the 60° axis and a second discrete, concave thinned area centered at about the 120° axis and a first discrete, thickened convex area centered at about 225° and a second discrete, thickened convex area one is centered at about 315°.

13. The lens of claim 12, wherein the coaxial stablization zone is substantially circular.

14. A soft contact lens comprising a convex surface, a concave surface, and at least one coaxial stabilization zone having a common axis of Z and located on one or both of the convex and concave surfaces, wherein the coaxial stabilization zone comprises at least one area of thickness, thinness, or both and wherein the surface on which the coaxial stabilization zone is located is a surface calculated from topographic measurements, wavefront measurements, or combinations thereof.

15. The soft contact lens of claim 14, wherein the coaxial stabilization zone is on the convex surface.

16. The soft contact lens of claim 14, wherein the surface on which the coaxial stabilization zone is located is a surface calculated from topographic measurements.

17. The soft contact lens of claim 14, wherein the surface on which the coaxial stabilization zone is located is a surface calculated from wavefront measurements.

18. The soft contact lens of claim 14, 15, 16, or 17, wherein the coaxial stabilization zone is substantially circular.

19. The soft contact lens of claim 18, wherein the coaxial stabilization zone comprises a discrete, concave thinned area centered at about the 90° axis and a first discrete, thickened convex area centered at about 210° and a second discrete, thickened convex area one is centered at about 330°.

20. The soft contact lens of claim 18, wherein the coaxial stabilization zone comprises a first discrete, concave thinned area centered at about the 60° axis and a second discrete, concave thinned area centered at about the 120° axis and a first discrete, thickened convex area centered at about 225° and a second discrete, thickened convex area one is centered at about 315°.

21. The lens of claim 14, wherein the coaxial stabilization zone extends from about 0 mm outside of an outer edge of an optic zone to about 1 mm inside of a lens edge.

22. A soft contact lens comprising a convex surface, a concave surface, and at least one substantially circular coaxial stabilization zone having a common axis of Z and located on the convex surface extending from about 0 mm outside of the optic zone to about 1 mm inside of the lens edge, wherein the coaxial stabilization zone comprises at least one area of thickness, thinness, or both and wherein the convex surface is a surface calculated from topographic measurements, wavefront measurements, or combinations thereof.

23. The soft contact lens of claim 22, wherein the surface on which the coaxial stabilization zone is located is a surface calculated from topographic measurements.

24. The soft contact lens of claim 22, wherein the surface on which the coaxial stabilization zone is located is a surface calculated from wavefront measurements.

25. The soft contact lens of claim 22, 23, or 24, wherein the coaxial stabilization zone comprises a discrete, concave thinned area centered at about the 90° axis and a first discrete, thickened convex area centered at about 210° and a second discrete, thickened convex area one is centered at about 330°.

26. The soft contact lens of claim 22, 23, or 24, wherein the coaxial stabilization zone comprises a first discrete, concave thinned area centered at about the 60° axis and a second discrete, concave thinned area centered at about the 120° axis and a first discrete, thickened convex area centered at about 225° and a second discrete, thickened convex area one is centered at about 315°.

27. A method for producing contact lenses comprising the steps of: a.) defining a coaxial stabilization zone for at least one surface of a contact lens having a common axis of Z and comprising at least one area of thickness, thinness, or both; b.) determining parameters for at least one area of thickness within the coaxial stabilization zone; and c.) calculating a surface design for the at least one surface.
